(19) United States
(12) Patent Application Publication
(10) Pub. No.: US 2014/0222292 A1
(43) Pub. Date: Aug. 7, 2014

(54) VEHICLE ELECTRIC POWER STEERING CONTROL SYSTEM

(71) Applicant: Steering Solutions IP Holding Corporation, Saginaw, MI (US)

(72) Inventors: Paul M. Fisher, Saginaw, MI (US); Darryl L. Greathouse, Essexville, MI (US); Timothy S. Keister, Linwood, MI (US); Eric D. Pattok, Frankenmuth, MI (US); Christian E. Ross, Freeland, MI (US); Patrik Ryne, Midland, MI (US); Tomy Sebastian, Saginaw, MI (US)

(73) Assignee: Steering Solutions IP Holding Corporation, Saginaw, MI (US)

(21) Appl. No.: 14/174,484

(22) Filed: Feb. 6, 2014

Related U.S. Application Data
(60) Provisional application No. 61/761,480, filed on Feb. 6, 2013.
(60) Provisional application No. 61/761,477, filed on Feb. 6, 2013.

(51) Int. Cl. B62D 5/04

(52) U.S. Cl. CPC B62D 5/0463; B62D 5/0403
USPC 701/41; 180/444

(57) ABSTRACT

A vehicle electric power steering (EPS) control system includes a motor operatively coupled to an EPS linkage arrangement, the motor comprising a first winding and a second winding. Also included is a power source for the motor. Further included is a controller in operative communication with the motor and the power source. The controller includes a microprocessor configured to receive input from a torque sensor and a motor sensor. The EPS controller also includes a first field-effect transistor (FET) driver in operative communication with the microprocessor and a first plurality of FETs operatively connected to the first winding of the motor. The EPS controller further includes a second FET driver in operative communication with the microprocessor and a second plurality of FETs operatively connected to the second winding of the motor.

### CROSS-REFERENCE TO RELATED APPLICATION

This patent application claims priority to U.S. Provisional Patent Application Ser. Nos. 61/761,480 and 61/761,477, both filed Feb. 6, 2013, both of which are incorporated herein by reference in their entirety.

### BACKGROUND OF THE INVENTION

Larger vehicles require significant force to turn the wheels during a steering action. It is difficult to provide the power required to produce this force using current controller technology. In the event of a controller shutdown, the loss of power steering assist would require more effort from the driver to steer the vehicle. The inadequate power steering assist is undesirable and may lead to poor consumer satisfaction and a perceived lack of quality.

### SUMMARY OF THE INVENTION

In accordance with the invention, a vehicle electric power steering (EPS) control system includes a motor operatively coupled to an EPS linkage arrangement, the motor comprising a first winding and a second winding. Also included is a power source for the motor and EPS control system. Further included is a controller in operative communication with the motor and the power source. The controller includes a microprocessor configured to receive input from a torque sensor and a motor sensor. The EPS controller also includes a first field-effect transistor (FET) driver in operative communication with the microprocessor and a first plurality of FETs operatively connected to the first winding of the motor. The EPS controller a second FET driver in operative communication with the microprocessor and a second plurality of FETs operatively connected to the second winding of the motor.

In accordance with another embodiment of the invention, a vehicle electric power steering (EPS) control system includes a motor operatively coupled to an EPS linkage arrangement, the motor comprising a first winding and a second winding. Also included is a power source configured to power the first winding and the second winding of the motor. Further included is a first electronic control unit (ECU) in operative communication with the power source and the first winding of the motor. The first ECU includes a first microprocessor configured to receive input from a first torque sensor and a first motor sensor. The first ECU also includes a first field-effect transistor (FET) driver in operative communication with the first microprocessor and a first plurality of FETs operatively connected to the first winding of the motor. The EPS control system yet further includes a second ECU in operative communication with the power source and the second winding of the motor. The second ECU includes a second microprocessor configured to receive input from a second torque sensor and a second motor sensor. The second ECU also includes a second field-effect transistor (FET) driver in operative communication with the second microprocessor and a second plurality of FETs operatively connected to the second winding of the motor.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically illustrates an electric power steering linkage arrangement;

FIG. 2 is a schematic diagram illustrating an electric power steering control system in accordance with an exemplary embodiment of the invention;

FIG. 3 is a schematic diagram illustrating the electric power steering control system in accordance with another exemplary embodiment of the invention; and

FIG. 4 is a schematic illustration of a motor of the electric power steering control system.

### DETAILED DESCRIPTION

Referring now to the Figures, where the invention will be described with reference to specific embodiments, without limiting same, the disclosed invention provides steering assist in a steering system required to provide high assist torque even when a system fault occurs.

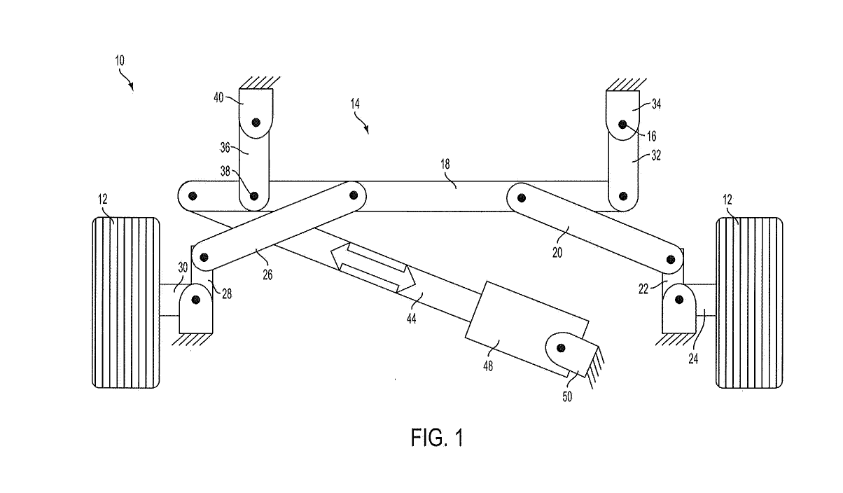

Referring to FIG. 1, a portion of a steering system 10 for a vehicle is schematically illustrated. The architecture of the steering system 10 is referred to as a “parallelogram” steering system. It is contemplated that the steering system 10 may be employed in numerous types of vehicles. In one embodiment, the steering system 10 is used in association with high assist applications, such as heavy or light duty trucks that have high static and dynamic steering load requirements, the requirements of which are known to a person of skill in the art.

The steering system 10 includes numerous components, such as various linkage members, sensors, switches, and accessories. The steering system 10 transfers rotation and torque from an input member, such as a steering wheel assembly (not illustrated) to an output member, such as one or more wheels 12. The steering wheel assembly is operatively coupled to a linkage arrangement 14 of the steering system 10 with a first shaft 16, which may be referred to as a pitman shaft. The wheels 12 of the vehicle are turned through movement of the linkage arrangement 14 and, more particularly, though movement of a cross-link member 18. The cross-link member 18 extends in a substantially transverse direction relative to vehicle travel, i.e. cross-car direction of the vehicle, and translates in this direction as well. Translation of the cross-link member 18 imparts movement of numerous other components that link the cross-link member 18 to the wheels 12 of the vehicle. Such intermediary components include a first tie rod 20 rotationally coupled to the cross-link member 18, as well as one or more additional linkage members 22 and a first steering knuckle 24 that pivots with respect to a frame of the vehicle. Similarly, a second tie rod 26 is rotationally coupled to the cross-link member 18 and is indirectly coupled to a wheel of the vehicle with a linkage member 28 and a second steering knuckle 30 that pivots with respect to the frame of the vehicle.

In the illustrated embodiment, the linkage arrangement 14 includes a first linkage arm 32 that is pivotally coupled to the cross-link member 18 at a location proximate the first shaft 16. The first linkage arm 32 is pivotally coupled to the frame of the vehicle via a first pivot joint 34 and is free to rotate in response to an input from the first shaft 16. A second linkage arm 36 is also pivotally coupled to the cross-link member 18 at a pivot location 38. The second linkage arm 36 is pivotally coupled to the frame of the vehicle via a second pivot joint 40 and is free to rotate.

A linkage member 44 extends from an electric motor 48 that is operatively coupled to the frame of the vehicle. The operative coupling of the electric motor 48 comprises a pivotal connection via a pivot joint 50. In the illustrated embodiment, the electric motor 48 is configured to translate the linkage member 44 in a substantially linear manner in the direction of the arrow shown in FIG. 1. The linkage member 44 is directly coupled to the cross-link member 18 proximate an end 52 of the linkage member 44. It is to be understood that coupling of the linkage member 44 to the cross-link member 18 may be present along any portion of the cross-link member 18. The illustrated coupling location is merely illustrative and is not intended to be limiting.

It is to be appreciated that the above-described linkage arrangement is merely exemplary and various alternative linkage arrangements may be employed in association with the control system described in detail herein.

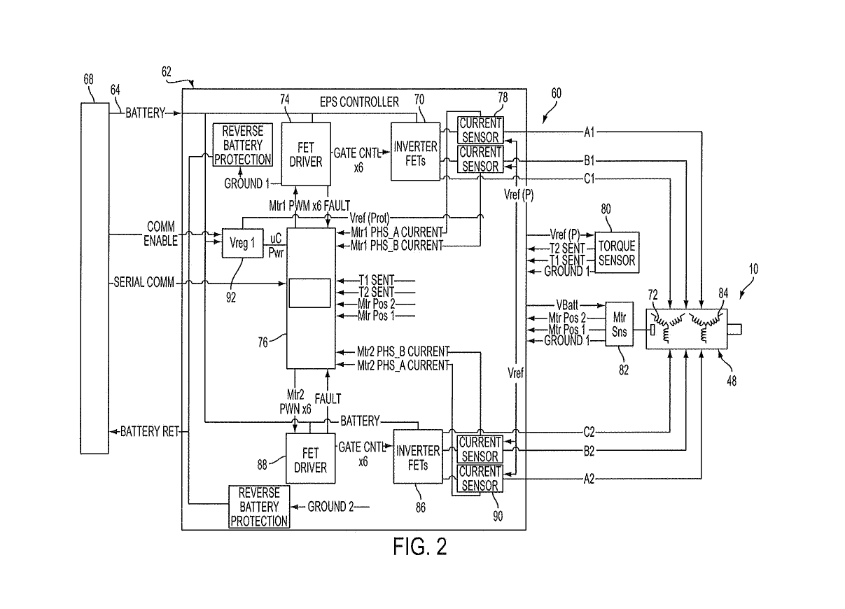

Referring now to FIG. 2, an exemplary embodiment of a control system 60 for the steering system 10 and, more specifically, the linkage arrangement 14 of the steering system 10. The control system 60 includes a controller 62 for controlling the electrical power supplied to the electric motor 48. The controller 62 includes a power input 64 for receiving electrical power. Typically, the electrical power is supplied by one or more batteries 68 and has a voltage. Current vehicle applications utilize 12 V systems. However, those skilled in the art should readily appreciate that other sources of the electrical power in the vehicle may be implemented and that other voltages may alternatively be suitable.

The controller 62 includes at least one, but typically a first plurality of power devices 70 electrically connected to the power input 64 and also connected to a first winding 72 of the electric motor 48. In operation, the first power devices 70 receive electrical power and variably provide the electrical power to the electric motor 48. In one embodiment, the first power devices 70 are inverter field-effect transistors (FETs), such as MOSFETs or some other suitable alternative power device. A first driver 74 is electrically connected to the first power devices 70 for regulating the operation of, and electric power provided to, the first power devices 70. By regulating the electric power provided to the first power devices 70, the first driver 74 regulates the electric power provided to the electric motor 48. The electric power is often provided in a variable manner that changes the amount of power steering assist provided by the electric motor 48, depending on certain vehicle conditions, as described herein.

The controller 62 also includes a microprocessor 76 electrically connected to the first driver 74 for controlling the first driver 74. Control of the first driver 74 is based on at least one signal input to the microprocessor 76 for regulating the amount of power supplied by the first power devices 70 to the electric motor 48. In one embodiment, the microprocessor 76 is a dual-core processor, but it is to be understood that suitable alternative processing devices may be employed. As noted above, the microprocessor 76 includes one or more signal inputs for power regulation purposes. These inputs include, but are not limited to, the electric current flowing through the first power devices 70, the speed of the electric motor 48, the positioning of a rotor of the electric motor 48, and the speed of the vehicle.

To provide a signal corresponding to the current flowing through the first power devices 70, the controller 62 includes at least one first current sensor 78 electrically connected to the first power devices 70. In the illustrated embodiment, two first current sensors are included to detect the current flowing through the first power devices 70. The first current sensor(s) 78 are in operative communication with the microprocessor 76. More specifically, the first current sensor(s) 78 are electrically connected to the microprocessor 76.

To provide a signal related to the torque applied at the steering column of the steering system 10, a torque sensor 80 is included. In the exemplary embodiment of the linkage arrangement 14 of FIG. 1, the torque sensor 80 is located proximate the first linkage arm 32 and, more specifically, proximate the first pivot joint 34 of the first linkage arm 32. A signal related to the position of the electric motor 48 is provided by a motor sensor 82 in operative communication with the electric motor 48. As will be appreciated from the description below, the electric motor 48 is a dual wound motor that includes the first winding 72 noted above and a second winding 84.

To provide redundancy for the steering system 10, the controller 62 includes a duplicative sub-system that may be referred to as a redundant, or secondary, sub-system. The components described in detail above may be referred to as a primary sub-system. It is to be appreciated that the primary sub-system and the redundant sub-system include overlapping components and are differentiated by duplicative components that include, but are not limited to, the second winding 84 of the electric motor 48, one or more second power devices 86, a second driver 88 and one or more second current sensors 90. In this system, both sub-systems would operate simultaneously, with each providing a portion of the overall power to the system. If one sub-system can no longer operate correctly, the other sub-system can continue to operate, providing a reduced level of total performance.

The second power devices 86 are electrically connected to the power input 64 and to a second winding 84 of the electric motor 48. In operation, the second power devices 86 receive electrical power and variably provide the electrical power to the electric motor 48. In one embodiment, the second power devices 86 are inverter field-effect transistors (FETs), such as MOSFETs or some other suitable alternative power device. The second driver 88 is electrically connected to the second power devices 86 for regulating the operation of, and electric power provided to, the second power devices 86. By regulating the electric power provided to the second power devices 86, the second driver 88 regulates the electric power provided to the electric motor 48. The electric power is often provided in a variable manner that changes the amount of power steering assist provided by the electric motor 48, depending on certain vehicle conditions, as described herein.

The microprocessor 76 is electrically connected to the second driver 88 for controlling the second driver 88. Control of the second driver 88 is based on at least one signal input to the microprocessor 76 for regulating the amount of power supplied by the second power devices 86 to the electric motor 48. As described above, the microprocessor 76 includes one or more signal inputs for power regulation purposes. These inputs include, but are not limited to, the electric current flowing through the second power devices 86, the speed of the electric motor 48, the positioning of a rotor of the electric motor 48, and the speed of the vehicle.

To provide a signal corresponding to the current flowing through the second power devices 86, the controller 62 includes the second current sensor(s) 90 that is electrically connected to the second power devices 86. In the illustrated embodiment, two second current sensors are included to detect the current flowing through the second power devices 86. The second current sensor(s) 90 are in operative communication with the microprocessor 76. More specifically, the second current sensor(s) 90 are electrically connected to the microprocessor 76.

As described above, a signal related to the position of the electric motor 48 is provided by a motor sensor 82 in operative communication with the electric motor 48. The motor sensor 82 is configured to detect and communicate to the microprocessor 76 the position of the first winding 72 and the second winding 84.

The controller 62 also includes a voltage regulator 92 that is in operative communication with the battery 68 and is configured to regulate and selectively route electric power to the primary sub-system and the redundant sub-system. The voltage regulator 92 is electrically connected to various components of the primary sub-system and the redundant sub-system.

In the above-described embodiment, the electric motor 48 comprises a dual winding motor and the overall control system includes dual motor control power devices (e.g., first and second power devices 70, 86). The electric motor 48 effectively comprises two three-phase motors available for powering electric assist to the linkage arrangement 14 of the steering system 10. Dual control with the addition of the redundant sub-system facilitates power steering assist in the event of failure of the first power devices 70 (i.e., first inverter set) and allows for more effective management of the thermal system losses by spreading the heat between two inverter groups.

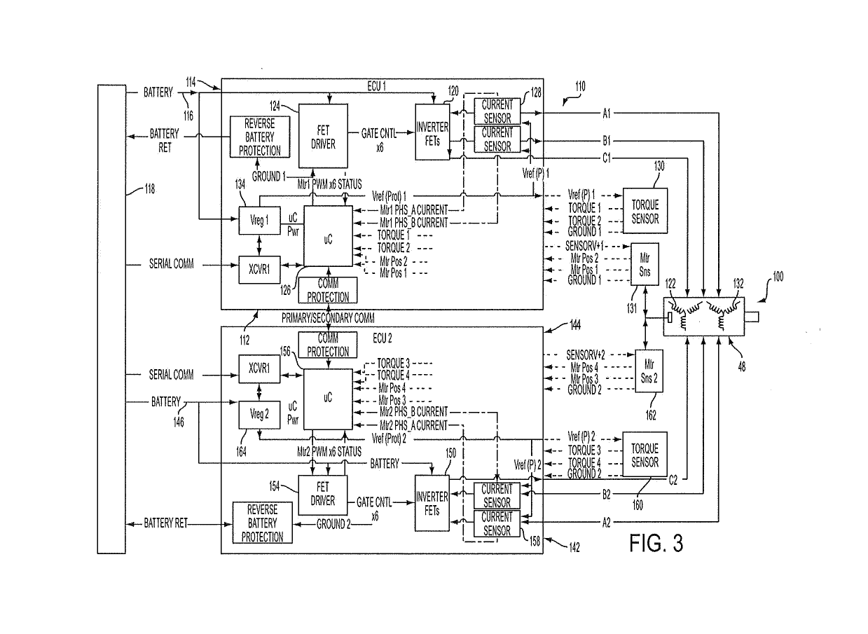

Referring now to FIG. 3, a steering system 100 is illustrated in accordance with another exemplary embodiment of the invention. The illustrated embodiment is similar in some respects to the embodiments described above in relation to FIG. 2 and includes similar components, such that description of identical components is not provided in a duplicative manner, where appropriate. In particular, the linkage arrangement 14 of the steering system 10 and components thereof are referred to with similar reference numerals. As will be described in detail below, the embodiment shown in FIG. 3 includes a control system that comprises a complete duplication of sub-systems that facilitates complete redundancy of the entire electronic system.

In the illustrated embodiment, the steering system 100 includes a control system 110 for the steering system 100 and, more specifically, the linkage arrangement 14 of the steering system 100. The control system 110 includes a primary sub-system 112 that includes a first electronic control unit (ECU) 114 for controlling the electrical power supplied to the electric motor 48. The first ECU 114 includes a first power input 116 for receiving electrical power. Typically, the electrical power is supplied from one or more batteries 118 and has a voltage. As noted above, current vehicle applications utilize 12 V systems. However, those skilled in the art should readily appreciate that other sources of the electrical power in the vehicle may be implemented and that other voltages may alternatively be suitable.

The first ECU 114 includes at least one, but typically a first plurality of power devices 120 electrically connected to the first power input 116 and to a first winding 122 of the electric motor 48. In operation, the first power devices 120 receive electrical power and variably provide the electrical power to the electric motor 48. In one embodiment, the first power devices 120 are inverter field-effect transistors (FETs), such as MOSFETs or some other suitable alternative power device. A first driver 124 is electrically connected to the first power devices 120 for regulating the operation of, and electric power provided to, the first power devices 120. By regulating the electric power provided to the first power devices 120, the first driver 124 regulates the electric power provided to the electric motor 48. The electric power is often provided in a variable manner that changes the amount of power steering assist provided by the electric motor 48, depending on certain vehicle conditions, as described herein.

The first ECU 114 also includes a first microprocessor 126 electrically connected to the first driver 124 for controlling the first driver 124. Control of the first driver 124 is based on at least one signal input to the first microprocessor 126 for regulating the amount of power supplied by the first power devices 120 to the electric motor 48. In one embodiment, the first microprocessor 126 is a dual-core processor, but it is to be understood that suitable alternative processing devices may be employed. As noted above, the first microprocessor 126 includes one or more signal inputs for power regulation purposes. These inputs include, but are not limited to, the electric current flowing through the first power devices 120, the speed of the electric motor 48, the positioning of a rotor of the electric motor 48, and the speed of the vehicle.

To provide a signal corresponding to the current flowing through the first power devices 120, the first ECU 114 includes at least one first current sensor 128 electrically connected to the first power devices 120. In the illustrated embodiment, two first current sensors are included to detect the current flowing through the first power devices 120. The first current sensor(s) 128 are in operative communication with the first microprocessor 126. More specifically, the first current sensor(s) 128 are electrically connected to the first microprocessor 126.

To provide a signal related to the torque applied at the steering column of the steering system 100, a first torque sensor 130 is included. In the exemplary embodiment of the linkage arrangement 14 of FIG. 1, the first torque sensor 130 is located proximate the first linkage arm 32 and, more specifically, proximate the first pivot joint 34 of the first linkage arm 32. A signal related to the position of the electric motor 48 is provided by a first motor sensor 131 in operative communication with the electric motor 48. The electric motor 48 is a dual wound motor that includes the first winding 122 noted above and a second winding 132. The first motor sensor 131 is configured to detect the position of the rotor in the electric motor 48 which is common to both windings 122, 132.

The first ECU 114 also includes a first voltage regulator 134 that is in operative communication with the battery 118 and is configured to regulate and selectively route electric power to the primary sub-system, specifically including the first driver 124, the first microprocessor 126 and the first current sensor(s) 128, among other potential components.

As noted above, complete redundancy of the control system 110 is achieved with a duplication of the components of the primary sub-system. Specifically, the control system 110 includes a redundant sub-system 142 that includes a second electronic control unit (ECU) 144 for controlling the electrical power supplied to the electric motor 48. The second ECU 144 includes a second power input 146 for receiving electrical power. Typically, the electrical power is supplied by the battery 118 and has a voltage. Once again, current vehicle applications utilize 12 V systems. However, those skilled in the art should readily appreciate that other sources of the electrical power in the vehicle may be implemented and that other voltages may alternatively be suitable.

The second ECU 144 includes at least one, but typically a second plurality of power devices 150 electrically connected to the second power input 146 and to the second winding 132 of the electric motor 48. In operation, the second power devices 150 receive electrical power and variably provide the electrical power to the electric motor 48. In one embodiment, the second power devices 150 are inverter field-effect transistors (FETs), such as MOSFETs or some other suitable alternative power device. A second driver 154 is electrically connected to the second power devices 150 for regulating the operation of, and electric power provided to, the second power devices 150. By regulating the electric power provided to the second power devices 150, the second driver 154 regulates the electric power provided to the electric motor 48. The electric power is often provided in a variable manner that changes the amount of power steering assist provided by the electric motor 48, depending on certain vehicle conditions, as described herein.

The second ECU 144 also includes a second microprocessor 156 electrically connected to the second driver 154 for controlling the second driver 154. Control of the second driver 154 is based on at least one signal input to the second microprocessor 156 for regulating the amount of power supplied by the second power devices 150 to the electric motor 48. In one embodiment, the second microprocessor 156 is a dual-core processor, but it is to be understood that suitable alternative processing devices may be employed. As noted above, the second microprocessor 158 includes one or more signal inputs for power regulation purposes. These inputs include, but are not limited to, the electric current flowing through the second power devices 150, the speed of the electric motor 48, the positioning of a rotor of the electric motor 48, and the speed of the vehicle.

To provide a signal corresponding to the current flowing through the second power devices 150, the second ECU 144 includes at least one second current sensor 158 electrically connected to the second power devices 150. In the illustrated embodiment, two second current sensors are included to detect the current flowing through the second power devices 150. The second current sensor(s) 158 are in operative communication with the second microprocessor 156. More specifically, the second current sensor(s) 158 are electrically connected to the second microprocessor 156.

To provide a signal related to the torque applied at the steering column of the steering system 100, a second torque sensor 160 is included. In the exemplary embodiment of the linkage arrangement 14 of FIG. 1, the second torque sensor 160 is located proximate the first linkage arm 32 and, more specifically, proximate the first pivot joint 34 of the first linkage arm 32. A signal related to the position of the electric motor 48 is provided by a second motor sensor 162 in operative communication with the electric motor 48. The second motor sensor 162 is configured to detect the position of the rotor in the electric motor 48 which is common to both windings 122, 132.

The second ECU 144 also includes a second voltage regulator 164 that is in operative communication with the battery 118 and is configured to regulate and selectively route electric power to the redundant sub-system, specifically including the second driver 154, the second microprocessor 156 and the second current sensor(s) 158, among other potential components.

In addition to two completely distinct ECUs, the components of each sub-system could be physically located on one printed circuit board (PCB) with separated copper layers.

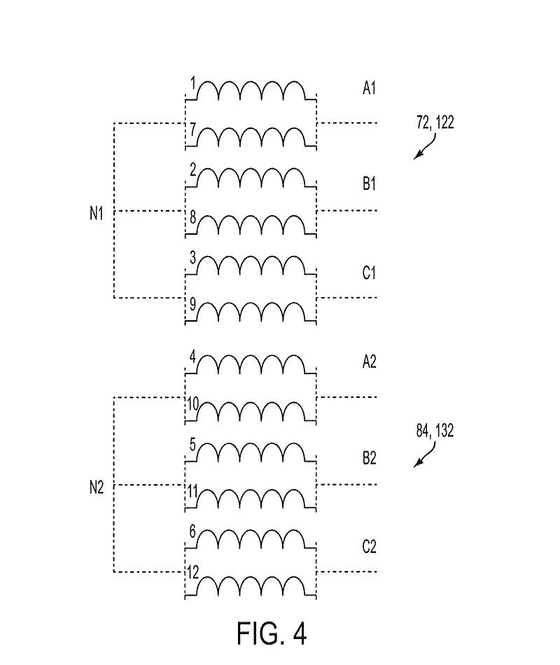

In all of the embodiments described above, the electric motor 48 contains a rotor shaft with magnets and a stator wound with coils for two independent sets of a three-phase motor. In one embodiment, the electric motor 48 comprises a 12-slot, eight-pole configuration, with the 12 poles schematically illustrated in FIG. 4. The physical copper windings are illustrated and schematically represent the first winding 72, 122 and the second winding 84, 132 of the embodiments described above in relation to the overall control system 60, 110. The 12-slot configuration allows the windings 122, 132 to be separated in such a way that the current flowing through the phases does not produce magnetic coupling fields on the other phases, or at least minimizes such fields.

Advantageously, the above-described embodiments provide steering assist torque to each independent winding in the electric motor 48 from their respective sub-systems (i.e., primary and redundant sub-systems). Each ECU 114, 144 is configured to diagnose its own sub-system faults and react accordingly. In the event an ECU fails to operate, the other ECU and its components will remain operational in a normal manner to provide steering assist for the driver to safely operate the vehicle. The redundant ECUs and dual wound motor provide reliability such that no single controller or sensor fault causes a complete loss of steering assist.

As described above, the sub-systems of the above-described embodiments include separate and isolated components that reduce or eliminate the possibility of one adversely impacting the other. In one embodiment, each sub-system provides about 50% of the power steering assist at normal operation. In other embodiments, one of the sub-systems provides the majority of the power steering assist. Based on this, the terms primary and secondary (or redundant) may represent which provides more power, but it is to be understood that the sub-systems can operate simultaneously and continue to do so if the other sub-system fails. This is distinct from a system that includes a “back-up” system that only begins to operate in the event of failure of another sub-system.

By providing a sub-system with duplication of some or all components of another sub-system, the EPS control system described herein facilitates a simple transition during a failure mode that allows a vehicle operator to maneuver the vehicle to safety with little noticeable impact to the driver. In addition, the dual wound motor system of the invention provides significant advantages when used in high load EPS applications, such as light or heavy duty trucks. A dual wound motor system is significantly less expensive than a single wound system capable of handling the same static and dynamic steering loads. It has the added advantage of providing the redundant or “back-up” system capability when one or the other system fails to operate. The Integration of the above-described embodiments with a dual wound motor is unique to an EPS system Both systems provide simultaneous steering assist which has particular utility in both cost effectiveness and redundancy for a high load system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A vehicle electric power steering (EPS) control system comprising:
a motor operatively coupled to an EPS linkage arrangement, the motor comprising a first winding and a second winding;
a power source for the motor; and
a controller in operative communication with the motor and the power source, the controller comprising:
a microprocessor configured to receive input from a torque sensor and a motor sensor;
a first field-effect transistor (FET) driver in operative communication with the microprocessor and a first plurality of FETs operatively connected to the first winding of the motor; and
a second FET driver in operative communication with the microprocessor and a second plurality of FETs operatively connected to the second winding of the motor.

2. The vehicle EPS control system of claim 1, further comprising:
at least one current sensor configured to detect a first winding current and communicate the detected current to the microprocessor; and
at least one current sensor configured to detect a second winding current and communicate the detected current to the microprocessor.

3. The vehicle EPS control system of claim 1, wherein the first FET driver and the first plurality of FETs comprise a primary sub-system, and wherein the second FET driver and the second plurality of FETs comprise a secondary sub-system configured to simultaneously provide steering assist with the primary sub-system.

4. The vehicle EPS control system of claim 3, further comprising a voltage regulator in operative communication with the power source and configured to detect and route a voltage to power a plurality of components of the primary sub-system and the secondary sub-system.

5. The vehicle EPS control system of claim 1, wherein the motor sensor detects a position of a rotor for control of the first winding of the motor and a position of a rotor for control of the second winding of the motor.

6. The vehicle EPS control system of claim 1, wherein the torque sensor detects a torque in a steering column operatively coupled to the motor.

7. The vehicle EPS control system of claim 1, wherein the first plurality of FETs and the second plurality of FETs each comprise a plurality of MOSFETs.

8. The vehicle EPS control system of claim 1, wherein the EPS linkage arrangement comprises:
a first linkage arm pivotally coupled to a cross-link member extending in a generally transverse direction;
a second linkage arm pivotally coupled to the cross-link member;
a first shaft operatively configured to rotate the first linkage arm; and
a linkage member extending from the motor and directly coupled to the cross-link member.

9. A vehicle electric power steering (EPS) control system comprising:
a motor operatively coupled to an EPS linkage arrangement, the motor comprising a first winding and a second winding;
a power source configured to power the first winding and the second winding of the motor;
a first electronic control unit (ECU) in operative communication with the power source and the first winding of the motor, the first ECU comprising:
a first microprocessor configured to receive input from a first torque sensor and a first motor sensor; and
a first field-effect transistor (FET) driver in operative communication with the first microprocessor and a first plurality of FETs operatively connected to the first winding of the motor;
a second ECU in operative communication with the power source and the second winding of the motor, the second ECU comprising:
a second microprocessor configured to receive input from a second torque sensor and a second motor sensor; and
a second field-effect transistor (FET) driver in operative communication with the second microprocessor and a second plurality of FETs operatively connected to the second winding of the motor.

10. The vehicle EPS control system of claim 9, further comprising:
at least one current sensor configured to detect a first winding current and communicate the detected current to the first microprocessor; and
at least one current sensor configured to detect a second winding current and communicate the detected current to the second microprocessor.

11. The vehicle EPS control system of claim 9, further comprising:
a first voltage regulator in operative communication with the power source and configured to detect and route a voltage to power a plurality of components of the first ECU; and
a second voltage regulator in operative communication with the power source and configured to detect and route a voltage to power a plurality of components of the second ECU.

12. The vehicle EPS control system of claim 11, wherein the first winding and the first ECU comprise a primary sub-system, and wherein the second winding and the second ECU comprise a secondary sub-system configured to simultaneously provide steering assist with the primary sub-system.

13. The vehicle EPS control system of claim 9, wherein the first motor sensor detects a position of a rotor for control of the first winding of the motor and communicates the position of the first winding to the first ECU, and wherein the second motor sensor detects a position of a rotor for control of the second winding of the motor and communicates the position of the second winding to the second ECU.

14. The vehicle EPS control system of claim 9, wherein the first torque sensor detects a torque in a steering column operatively coupled to the motor and communicates the detected torque to the first ECU, and wherein the second torque sensor detects a torque in the steering column and communicates the detected torque to the second ECU.

15. The vehicle EPS control system of claim 9, wherein the EPS linkage arrangement comprises:
a first linkage arm pivotally coupled to a cross-link member extending in a transverse direction;
a second linkage arm pivotally coupled to the cross-link member;
a first shaft operatively configured to rotate the first linkage arm; and
a linkage member extending from the motor and directly coupled to the cross-link member.

16. The vehicle EPS control system of claim 9, wherein the first plurality of FETs and the second plurality of FETs each comprise a plurality of MOSFETs.

17. The vehicle EPS control system of claim 9, wherein the microprocessor comprises a dual-core microprocessor.

18. The vehicle EPS control system of claim 9, wherein the motor comprises a three-phase motor.

19. The vehicle EPS control system of claim 9, wherein the motor comprises a 12-slot, 8-pole motor configured to reduce coupling of magnetic fields.
